(19) United States
(12) Patent Application Publication
(10) Pub. No.: US 2004/0120780 A1
(43) Pub. Date: Jun. 24, 2004

(54) Split-pin drill jig

(76) Inventor: Graham Massey, Chester (GB)

Correspondence Address: NIXON & VANDERHYE, PC, 1100 N GLEBE ROAD, 8TH FLOOR, ARLINGTON, VA, 22201-4714, US

(21) Appl. No.: 10/475,746

(22) PCT Filed: Jun. 12, 2002
(86) PCT No.: PCT/GB02/02701

(30) Foreign Application Priority Data
Jun. 21, 2001 (GB) 0115195.0

(51) Int. Cl. B23B 49/02

(52) U.S. Cl. 408/115 B; 408/115 R

(57) ABSTRACT

A manufacturing jig (50) for drilling a hole (40) in a bolt (10), the hole (40) having a castellated nut (20) assembled on the bolt (10), wherein the jig (50) includes a housing locatable on the assembled nut and bolt and a drill bush (60) located and aligned to allow a generally diametrical hole (40) to be drilled in the bolt (10) to receive a split pin.

The present invention relates to manufacturing jig design and is particularly concerned with tools for enabling the drilling of holes in bolts.

A commonly-used means for preventing nuts coming loose from bolts in service is the use of split pins. Typically, a split pin is inserted between the castellations of a special castellated nut, and through a hole in the bolt, until the head of the pin fits between two castellations. The split ends of the pin are then bent over, thus retaining the pin in the hole and locking the nut onto the bolt. A potential drawback to this method of using split pins is that, when the nut is tightened on the bolt, the gaps between the castellations may not line up with the pre-drilled hole in the bolt.

To overcome this potential drawback, another method of using split pins is to assemble a nut onto a bolt, tighten it to the required specified torque, and then drill, freehand, through the bolt, using the gap between the castellations as an approximate guide. This is an awkward process in a production scenario as access for drilling is often restricted, and it is difficult for the operator to drill accurately freehand. In practice this sometimes results in broken drills or incorrectly-drilled split-pin holes. If the drill breaks off in the bolt, the rectification process to remove and replace the bolt and nut is difficult and time-consuming, and therefore expensive. An improved method of drilling split-pin holes would therefore be an advantage for production processes that require the locking of nuts using split pins.

According to the present invention there is provided a jig for drilling a split-pin hole, in a suitable position, in a bolt which has a castellated nut assembled onto it. The jig includes a housing locatable on the assembled nut and bolt and a drill bush located and aligned to allow a generally diametrical hole to be drilled in the bolt to receive the split pin.

The body of the jig may be manufactured from a bar of metallic material which is machined, or otherwise formed, internally to form a hexagonal internal hole. Alternatively the jig body may be manufactured from a standard hexagonal socket as ordinarily used for tightening and loosening nuts. In either case, the size of the hexagonal internal hole is chosen such that it fits closely over the six faces of the castellated nut. Additionally, the hexagonal hole may be differently-sized at the two ends of the bar to fit two different sizes of nut.

The jig has one radial hole through its wall, which hole may be coincident with the centre of an internal flat surface. Into the radial hole is secured a drill bush of an appropriate size to guide the drill bit required to drill the split-pin hole.

In use, the jig is placed over the nut and bolt so that the axis of the hexagonal hole in the jig is substantially coincident with the axis of the bolt. The jig is pushed down onto the nut and bolt until a lcation means, which is part of the jig, engages with the nut and locates the jig in a suitable position to enable the drilling operation to take place. This location means may be provided by at least one further radial hole through the jig wall where each hole may be coincident with the centre of a different internal flat surface. A locating pin may be inserted into each hole so that it projects a short distance into the hexagonal hole, the pins being secured in their holes by some means such as an interference fit or an adhesive. The projections of the pins into the hexagonal hole engage with the gaps between the castellations of the nut when the jig is placed over the nut. Preferably, up to four further locating pins may be provided in this way in order to locate the jig securely in relation to the nut and bolt and especially to reduce wobbling of the jig whilst the split-pin hole is being drilled.

To enable suitable location of the jig, the centres of the holes for the drill bush and locating pins may lie in the same plane, which is orthogonal to the longitudinal axis of the hexagonal hole. Furthermore, the diameter of the locating pins may be chosen such that, when the jig is placed over the castellated nut, the pins fit between the castellations of the nut so that the jig is located in a suitably secure manner.

An embodiment of the present invention will now be described with reference to the accompanying drawings in which:

FIG. 1 shows a bolt and castellated nut assembly.

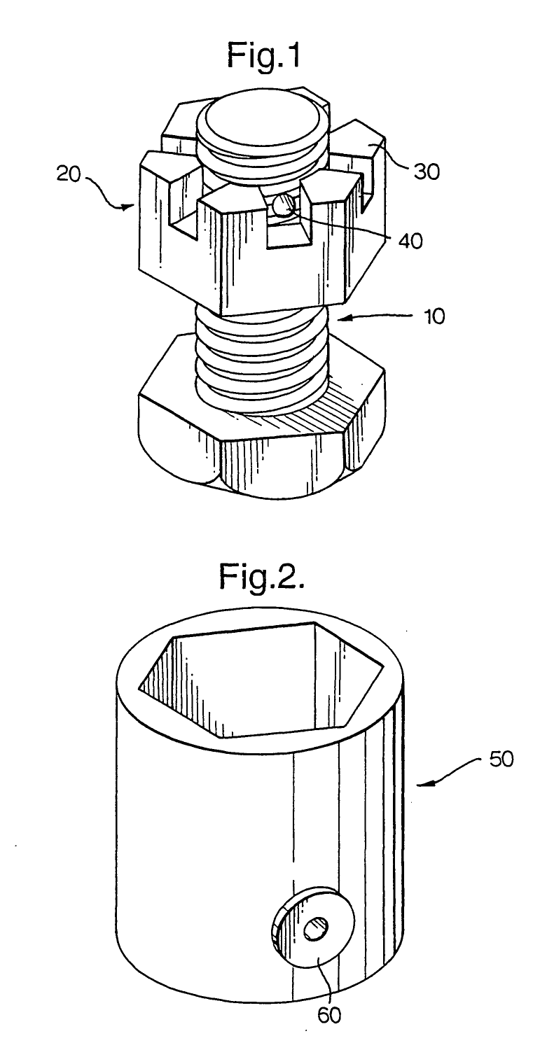

FIG. 2 shows a pictorial view of a split-pin drill jig.

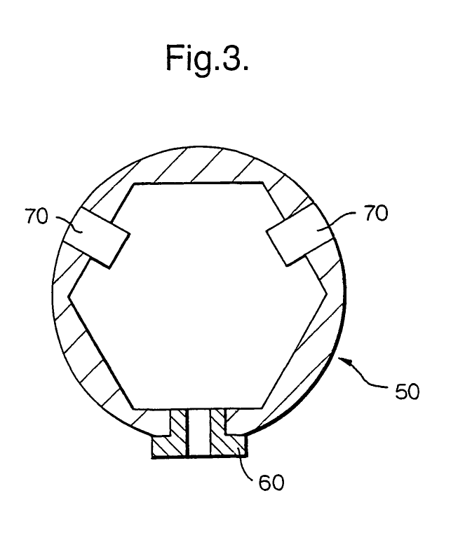

FIG. 3 shows a section through FIG. 2 where the drill bush and locating pins are inserted.

Referring first to FIG. 1, there is shown a bolt 10 and a castellated nut 20. As shown, there are six castellations 30 on a typical castellated nut The hole 40 through the bolt 10 is shown in the correct position ready for the insertion of a split pin to lock the nut in place on the bolt. According to the prior art, the hole 40 was drilled, freehand, diametrically through the bolt 10 from one side to the other with the nut 20 in situ on the bolt 10.

FIGS. 2 and 3 show the drill jig 50 with drill bush 60 and locating pins 70. When the drill jig 50 is placed over the nut 20, the locating pins 70 engage in the gaps between the castellations 30. This locates the drill jig 50 on the nut 20 so that a drill inserted in the drill bush 60 will drill the hole 40 in the correct location and direction.

1. A jig for drilling a hole in a bolt, the hole having a castellated nut assembled on the bolt, wherein the jig includes a housing locatable on the assembled nut and bolt and a drill bush located and aligned to allow a generally diametrical hole to be drilled in the bolt to receive a split pin.

2. A jig as claimed in claim 1 wherein the jig body is manufactured from a hollow metal bar with a longitudinal hexagonal cut-out defined therein.

3. A jig as claimed in claim 1 wherein the jig body is manufactured from a standard hexagonal socket.

4. A jig as claimed in claim 1 that has two ends wherein the two ends are sized to co-operate with different-sized nuts.

5. A jig as claimed in any preceding claim comprising means for axially locating the jig on the nut and bolt so that the hole can be drilled in the bolt at a suitable location.

6. A method for drilling a generally diametrical hole in a bolt, having a castellated nut located thereon, said hole being located and aligned in a suitable manner so as to receive a split pin which locks in place said nut, in which a drill jig is placed onto the nut and bolt assembly and a drill bush, being part of the jig, is used to guide a drill bit so that it may drill said hole.
